(19) United States
(12) Patent Application Publication
(10) Pub. No.: US 2026/0152365 A1
(43) Pub. Date: Jun. 4, 2026

(54) ELEVATOR SAFETY BRAKE ARRANGEMENT

(71) Applicant: Otis Elevator Company, Farmington, CT (US)

(72) Inventor: Juan Antonio Illan, Las Rozas, Madrid (ES)

(21) Appl. No.: 19/258,319

(22) Filed: Jul. 2, 2025

(30) Foreign Application Priority Data
Jul. 11, 2024 (EP) 24382747.4

(51) Int. Cl. B66B 5/22

(52) U.S. Cl. CPC B66B 5/22

(57) ABSTRACT

An elevator safety brake arrangement (20) includes a first safety brake (30) and a second safety brake (40). The first safety brake (30) includes a first elastic element (36) extending at a first angle (α) with respect to the longitudinal direction (L), defining a first tapered region between the passage (25) and the first elastic element (36). The second safety brake (40) includes a second elastic element (46) extending at a second angle (β) with respect to the longitudinal direction (L), defining a second tapered region between the passage (25) and the second elastic element (46). The elastic properties of the first elastic element (36) differ from the elastic properties of the second elastic element (46).

### FOREIGN PRIORITY

This application claims priority to European Patent Application No. 24382747.4, filed Jul. 11, 2024, and all the benefits accruing therefrom under 35 U.S.C. § 119, the contents of which in its entirety are herein incorporated by reference.

### TECHNICAL FIELD OF INVENTION

The invention relates to an elevator safety brake arrangement. The invention further relates to an elevator car, to an elevator counterweight and to an elevator system respectively comprising at least one elevator safety brake arrangement.

### BACKGROUND OF THE INVENTION

An elevator system typically comprises at least one elevator car, which is configured for moving along a hoistway extending between a plurality of landings, and a driving system, which is configured for driving the elevator car. Optionally, the elevator system may further include an elevator counterweight moving concurrently and in opposite direction with respect to the elevator car.

In order to ensure a safe operation, an elevator system comprises usually at least one elevator safety brake. The at least one elevator safety brake is configured for braking movement of the elevator car and/or movement of the elevator counterweight relative to a guide member, such as a guide rail in an emergency situation. Such emergency situations may in particular include situations, in which the movement of the elevator car and/or the movement of the elevator counterweight exceeds a predetermined speed and/or acceleration. An elevator safety brake usually includes at least one engagement member, such as a brake shoe or a roller, that is configured for engaging with the guide member, when the elevator safety brake is activated, for decelerating and stopping the movement of the elevator safety brake along the guide member.

For enhancing the safety of the elevator system even further, two or more elevator safety brakes, which are spaced apart from each other along a longitudinal extension of the guide member, may be provided at the elevator car and/or at the elevator counterweight, respectively.

When a plurality of elevator safety brakes, which are arranged along the longitudinal extension of the same guide member, are activated, the at least one engagement member of a leading elevator safety brake, which is arranged at the head of the plurality of elevator safety brakes moving along the guide member, engages with a “clean” or “fresh” portion of the guide member, i.e. with a portion of the guide member, which is in its original state, since it has not been in contact with an engagement member of a safety brake before.

The at least one engagement member of a trailing elevator safety brake, which, in the moving direction of the plurality of elevator safety brakes, is arranged behind the leading elevator safety brake, engages with a portion of the guide member that has already been in engagement with the at least one engagement member of the leading elevator safety brake moving in front of the second elevator safety brake.

In consequence, the surface characteristics of the portion of the guide member contacted by the trailing safety brake may differ from the surface characteristics of the portion of the guide member contacted by the leading safety brake.

The at least one engagement member of the leading safety brake may, for example, have created scratches, dents or other marks on or within the surface of the guide member. Alternatively or additionally, material, in particular debris, of the at least one engagement member or of other components of the leading safety brake may have separated from the leading safety brake and stick to a portion of the guide member, thereby changing the adhesive and/or frictional properties of said portion of the guide member.

As a result, the braking characteristics of the trailing safety brake may differ from the braking characteristics of the leading safety brake. The leading and trailing safety brakes may, in particular, have different braking capacities. This may result in an uneven distribution of the braking loads over the plurality of safety brakes.

### SUMMARY OF THE INVENTION

It would therefore be beneficial to provide an improved elevator safety brake arrangement comprising at least two elevator safety brakes, which are configured for engaging, in an activated condition, with the same guide member, wherein the elevator safety brake arrangement allows to adapt the brake performance of the at least two elevator safety brakes to the condition of the guide member.

According to an exemplary embodiment of the invention, an elevator safety brake arrangement, which is provided for being attached to an elevator car and/or to an elevator counterweight and which is configured for braking movement of the elevator car or of the elevator counterweight in an emergency situation, defines a passage extending in a longitudinal direction through the elevator safety brake arrangement for allowing a longitudinal guide member, such as a guide rail, to pass through said passage. The longitudinal direction may be oriented in a vertical direction. Alternatively, the longitudinal direction may be inclined with respect to the vertical direction.

An elevator safety arrangement according to an exemplary embodiment of the invention comprises at least two safety brakes, including a first safety brake and a second safety brake. The first and second safety brakes are spaced apart from each other along the longitudinal direction.

The first safety brake comprises a first brake shoe arranged on one side of the passage. The first safety brake further comprises a first roller and a first elastic element, which are arranged on an opposite side of the passage. The first elastic element extends at a first angle with respect to the longitudinal direction, so that a proximal end of the first elastic element is closer to the passage than a distal end of the first elastic element, thereby defining a first tapered region between the passage and the first elastic element. At least in an activated condition of the first safety brake, the first roller is located within said first tapered region defined by the passage and the first elastic element. The first roller is capable of moving along the first elastic element towards the proximal end of the first elastic element into a wedged condition between the first elastic element and a guide member passing through the passage, in which the first elastic element exerts a first pressing force onto the first roller, pressing the first roller against the guide member.

The second safety brake comprises a second brake shoe arranged on one side of the passage. The second safety brake further comprises a second roller and a second elastic element, which are arranged on an opposite side of the passage. The second elastic element extends at a second angle with respect to the longitudinal direction, so that a proximal end of the second elastic element is closer to the guide member than a distal end of the second elastic element, thereby defining a second tapered region between the passage and the second elastic element. At least in an activated condition of the first safety brake, the second roller is located within said second tapered region defined by the passage and the second elastic element. The second roller is capable of moving along the second elastic element towards the proximal end of the second elastic element into a wedged condition between the second elastic element and the guide member passing through the passage, in which the second elastic element exerts a second pressing force onto the second roller, pressing the second roller against the guide member.

The proximal ends of the first and second elastic elements are oriented towards a first end of the elevator safety arrangement, and the distal ends of the first and second elastic element are oriented towards a second end of the elevator safety arrangement, which is opposite to the first end of the elevator safety arrangement along the longitudinal direction.

For braking a downward movement of the elevator safety arrangement, the first end of the elevator safety arrangement may be an upper end of the elevator safety arrangement, so that the proximal ends of the first and second elastic elements are oriented towards an upper end of the elevator safety arrangement; and the second end of the elevator safety arrangement may be a lower end of the elevator safety arrangement, so that the distal ends of the first and second elastic elements are oriented towards a lower end of the elevator safety arrangement, when the elevator safety arrangement is installed within an elevator system.

For braking an upward movement of the elevator safety arrangement, the first end of the elevator safety arrangement may be a lower end of the elevator safety arrangement, so that the proximal ends of the first and second elastic elements are oriented towards a lower end of the elevator safety arrangement; and the second end of the elevator safety arrangement may be an upper end of the elevator safety arrangement, so that the distal ends of the first and second elastic elements are oriented towards an upper end of the elevator safety arrangement, when the elevator safety arrangement is installed within an elevator system.

For activating the first elevator safety bake, the first roller is moved towards the guide member by an actuator, causing the first roller to be sandwiched between the guide rail and the first elastic element. Due to frictional engagement between the first roller and the guide member, the first roller is moved towards the proximal end of the first elastic element, when the first elevator safety device moves along the guide rail, into a wedged condition between the first elastic element and the guide member, thereby braking the movement of the first safety brake along the guide member.

Similarly, for activating the second elevator safety bake, the second roller is moved towards the guide member by an actuator causing the second roller to be sandwiched between the guide rail and the second elastic element. Due to frictional engagement between the second roller and the guide member, the second roller is moved towards the proximal end of the second elastic element, when the second elevator safety device moves along the guide rail, into a wedged condition between the second elastic element and the guide member, thereby braking the movement of the second safety brake along the guide member.

A single actuator may be provided for activating the first and second safety brakes.

Alternatively, for example for enhancing the safety of the elevator system even further by providing additional redundancy, two separate actuators may be provided for activating the first and second safety brakes.

In an elevator safety brake arrangement according to an exemplary embodiment of the invention, the elastic properties of the first elastic element differ from the elastic properties of the second elastic element.

In consequence, after the first and second safety brakes of the elevator safety brake arrangement have been activated, causing the first roller to roll along the guide member and the first elastic element, and causing the second roller to roll along the guide member and the second elastic element, the elastic forces, which are applied to the first roller by the first elastic element differ from the elastic forces, which are applied to the second roller by the second elastic element.

Providing the first elastic element and the second elastic element with different elastic properties allows for separately and individually adjusting the forces pressing the first roller against the guide member and the forces pressing the second roller against the second guide member after the elevator safety brake arrangement has been activated.

In an elevator safety brake arrangement according to an exemplary embodiment of the invention, the elastic properties of the first and second elastic elements may in particular be set differently for at least partially compensating for different adhesive and/or frictional properties of “new” and “used” portions of the guide member, i.e. between portions of the guide member, which are in an original state, since they have not been in contact with an engagement member of a safety brake, and portions of the guide member, which are not in the original state anymore, since they have been in contact with the at least one engagement member of the first safety brake.

At least partially compensating for different adhesive and/or frictional properties of “new” and “used” portions of the guide member allows to adapt the brake performance of the at least two elevator safety brakes to the condition of the guide member.

The forces applied to each of the first and second rollers by the first and second elastic elements vary as they roll along the elastic elements since the first and second rollers become increasingly wedged between the guide member and the corresponding elastic element.

The forces in particular increase when the rollers approach the proximal ends of the elastic elements.

A number of optional features of an elevator safety device according to an exemplary embodiment of the invention are set out in the following. These features may be realized in particular embodiments, alone or in combination with any of the other features, unless explicitly stated otherwise.

In an embodiment, the elastic properties of the first and second elastic elements may be set so that the average force applied to the first roller, when it rolls along the first elastic element, is larger than the average force applied to the second roller, when it rolls along the second elastic element.

In an alternative embodiment, the elastic properties of the first and second elastic elements may be set so that the average force applied to the first roller, when it rolls along the first elastic element, is smaller than the average force applied to the second roller, when it rolls along the second elastic element.

In an embodiment, the first and second safety brakes are combined with each other in a single device, forming an integrated elevator safety brake arrangement, which may be installed within an elevator system similar to a single elevator safety brake. Such an integrated configuration providing a single device may facilitate the installation of an elevator safety brake arrangement according to an exemplary embodiment of the invention in an elevator system.

In an alternative embodiment, the first and second safety brakes are provided separately form each other as two separate devices. The first and second safety brakes may in particular be provided with two separate housings. An embodiment, in which the two safety brakes are provided as separate devices, may allow for varying the distance between the first and second safety brakes along the longitudinal direction. This may provide additional flexibility for mounting the first and second safety brakes to an elevator car or to an elevator counterweight, respectively.

In an embodiment the first elastic element has a different elastic module than the second elastic element, for providing two elastic elements having different elastic properties. The first elastic element may, in particular, be made of a first material and the second elastic element may be made of a second material, which differs from the first material, and wherein the second material has a different elastic module than the first material.

In an alternative embodiment, the first and second elastic elements are made from the same material.

In an embodiment, for providing two elastic elements having different elastic properties, the first elastic element has a different length than the second elastic element.

In an alternative embodiment, the first and second elastic elements have the same length.

In an embodiment, for providing two elastic elements having different elastic properties, the first elastic element has a different thickness than the second elastic element.

In an alternative embodiment, the first and second elastic elements have the same thickness.

In an embodiment, for providing different elastic properties of the first and second elastic elements, the first angle, at which the first elastic element extends with respect to the longitudinal direction, differs from the second angle, at which the second elastic element extends with respect to the longitudinal direction.

In an alternative embodiment, the first elastic element and the second elastic element are arranged at the same angle with respect to the longitudinal direction.

In an embodiment, at least one of the first and second elastic elements comprises at least one leaf spring. Employing leaf springs allows for providing reliable elastic elements at low costs.

In an embodiment, at least one of the first and second elastic elements comprises a leaf spring package including a plurality of leaf springs. For providing first and second elastic elements with different elastic properties, the second elastic element may in particular comprise a different number of leaf springs than the first elastic element.

In an embodiment, the first and second elastic elements are located on the same side of the passage.

In an alternative embodiment, the first and second elastic elements are located on opposite sides of the passage.

Exemplary embodiments of the invention further include an elevator system comprising: a hoistway, extending between a plurality of landings; at least one guide rail extending in a longitudinal direction within the hoistway between the plurality of landings; at least one elevator car configured for moving along the guide rail between the plurality of landings; and at least one elevator safety brake arrangement according to an exemplary embodiment of the invention. The at least one elevator safety brake arrangement is attached to the at least one elevator car, and the at least one guide rail passes through the passage formed by the at least one elevator safety brake arrangement.

The longitudinal direction may be oriented in a vertical direction. Alternatively, the longitudinal direction may be inclined with respect to the vertical direction.

In such an elevator system, the movement of the at least one elevator car may be braked in an emergency situation by activating the safety brakes of the at least one elevator safety brake arrangement.

In an embodiment, the elevator system further comprises at least one elevator counterweight, which is configured for moving concurrently and in opposite direction with respect to the at least one elevator car along at least one elevator counterweight guide rail; and at least one elevator safety brake arrangement according to an exemplary embodiments of the invention, which is attached to the at least one elevator counterweight, wherein the at least one elevator counterweight guide rail passes through the passage defined by the elevator safety brake arrangement.

Such a configuration allows for additionally braking the movement of the at least one elevator counterweight in an emergency situation by activating the safety brakes of the at least one elevator safety brake arrangement.

In an embodiment of an elevator system, in at least one elevator safety brake arrangement, the proximal end of the first elastic element is arranged above the distal end of the first elastic element; and the proximal end of the second elastic element is arranged above the distal end of the second elastic element. Such an elevator safety brake arrangement is capable of braking a downward movement of an elevator car or of an elevator counterweight, to which it is attached.

In an embodiment of an elevator system, in at least one elevator safety brake arrangement, the proximal end of the first elastic element is arranged below the distal end of the first elastic element; and the proximal end of the second elastic element is arranged below the distal end of the second elastic element. Such an elevator safety brake arrangement is capable of braking a upward movement of an elevator car or of an elevator counterweight to which it is attached.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 shows a perspective view of an elevator car according to an exemplary embodiment of the invention.

FIG. 3 depicts a schematic plan view of an elevator safety brake according to an exemplary embodiment of the invention in an activated state.

FIG. 4 depicts a schematic plan view of an elevator safety brake according to another exemplary embodiment of the invention in an activated state.

### DETAILED DESCRIPTION OF THE INVENTION

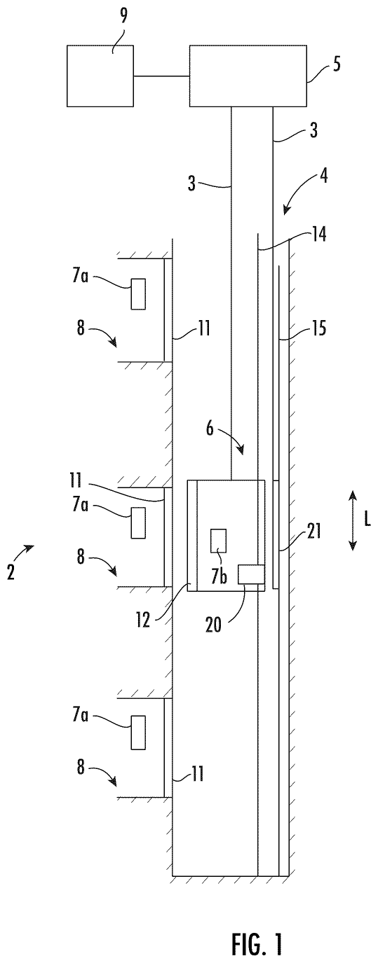

FIG. 1 schematically depicts an elevator system 2 according to an exemplary embodiment of the invention.

The elevator system 2 comprises a hoistway 4 extending in a longitudinal direction L between a plurality of landings 8, which are located on different floors. The elevator system 2 includes an elevator car 6, which is arranged within the hoistway 4 for being moved along the longitudinal direction L between the plurality of landings 8. The elevator car 6 is movable in particular in along at least one elevator car guide member 14, such as at least one elevator car guide rail, which is provided within the hoistway 4 and which extends along the longitudinal direction L.

The longitudinal direction L may be oriented in a vertical direction, as it is depicted in FIG. 1. In an alternative embodiment, which is not depicted in the figures, the longitudinal direction L may be inclined with respect to the vertical direction.

Only one of said elevator car guide members 14 is visible in FIG. 1. Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3. The tension member 3 is coupled to an elevator drive system 5, which is configured for driving the tension member 3 in order to move the elevator car 6 along the height of the hoistway 4 between the plurality of landings 8. The elevator drive system 5 is controlled by an elevator system controller 9.

The tension member 3 may be a rope, e.g. a steel cord, or a belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping or a 4:1 roping may be used as well.

The elevator system 2 depicted in FIG. 1 also includes an elevator counterweight 21. The elevator counterweight 21 is attached to the tension member 3 opposite to the elevator car 6 and configured to move concurrently and in opposite direction with respect to the elevator car 6 along at least one elevator counterweight guide member 15. Although an elevator counterweight 21 is depicted in FIG. 1, the invention may be similarly applied to elevator systems 2 that do not comprise an elevator counterweight 21.

In an alternative configuration, which is not shown in the figures, the elevator system 2 may be an elevator system 2 without a tension member 3. Instead, the elevator system 2 may include, for example, a hydraulic drive system or a linear drive system. The elevator system 2 may have a machine room, which is not shown in FIG. 1, or it may be a machine room-less elevator system 2.

A landing door 11 is provided at each of the landings 8, and the elevator car 6 is provided with a corresponding elevator car door 12 for allowing passengers to transfer between a landing 8 and the interior of the elevator car 6, when the elevator car 6 is positioned at the respective landing 8.

Input to the elevator system controller 9 may be provided via landing control panels 7a, which are provided on every landing 8, in particular in the vicinity of the landing doors 11, and/or via an elevator car control panel 7b, which is provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6, since the elevator system 2 is fully controlled by the commands input via the landing control panels 7a.

The landing control panels 7a and the elevator car control panel 7b may be connected to the elevator system controller 9 by means of electrical wiring, which are not shown in FIG. 1, in particular by an electric bus, or by means of wireless data connections.

The elevator car 6 is equipped with at least one elevator safety brake arrangement 20, which is schematically illustrated at the elevator car 6 in FIG. 1.

The elevator safety brake arrangement 20 is operable to brake or at least to assist in braking, i.e. slowing or stopping the movement of, the elevator car 6 by engaging with the at least one elevator car guide member 14.

Alternatively or additionally, the elevator counterweight 21 may be equipped with at least one elevator safety brake arrangement 20, which is configured for engaging with the at least one elevator counterweight guide member 15.

For sake of simplicity of the illustration, the elevator counterweight 21 depicted in FIG. 1 is not equipped with an elevator safety brake arrangement 20.

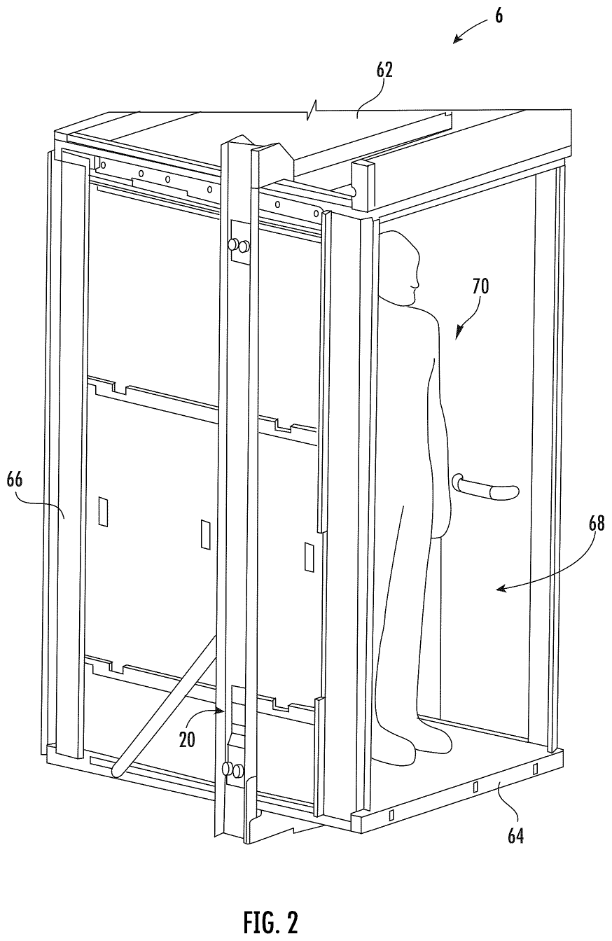

FIG. 2 is an enlarged view of an elevator car 6 according to an exemplary embodiment of the invention. The elevator car 6 includes a car roof 62, a car floor 64 and a plurality of car side walls 66. In combination, the car roof 62, the car floor 64 and the plurality of side walls 66 define an interior space 68 of the elevator car 6 for accommodating and carrying passengers 70 and/or cargo. For sake of simplicity of the illustration, cargo is not shown in FIG. 2.

An elevator safety brake arrangement 20 according to an exemplary embodiment of the invention is attached to a side wall 66 of the elevator car 6.

Although only a single elevator safety brake arrangement 20 is depicted in FIGS. 1 and 2, respectively, the elevator car 6 and the elevator counterweight 21 may be equipped with a plurality of safety brake arrangements 20, respectively.

In particular, in a configuration in which the elevator system 2 comprises a plurality of elevator car guide members 14, each elevator car 6 may be equipped with a plurality of elevator safety brake arrangements 20. Each of the plurality of elevator safety brake arrangements 20 may be associated with one of the elevator car guide members 14, respectively.

Similarly, in a configuration, in which the elevator system 2 comprises a plurality of elevator counterweight guide members 15, each elevator counterweight 21 of the elevator system 2 may be equipped with a plurality of elevator safety brake arrangements 20. Each elevator safety brake arrangement 20 may be associated with one of the elevator counterweight guide members 15, respectively.

Alternatively or additionally, two or more elevator safety brake arrangements 20 may be provided on top of each other at the same sidewall 66 of the elevator car 6 or of the elevator counterweight 21 in order to engage with the same guide member 14, 15.

A safety brake arrangement 20 is usually operable for braking its movement with respect to the guide member 14, 15 in only one direction along the extension of the guide member 14, 15. The elevator car 6 and/or the elevator counterweight 21 may therefore be equipped with at least two elevator safety brake arrangements 20, which are configured for braking the movement with respect to the guide member 14, 15 in opposite directions.

The at least two elevator safety brake arrangements 20 may in particular include a first elevator safety brake arrangement 20, which is configured for braking a downward movement of the elevator car 6/elevator counterweight 21 with respect to the guide member 14, 15; and a second elevator safety brake arrangement 20, which is configured for braking an upward movement of the elevator car 6/elevator counterweight 21 with respect to the guide member 14, 15.

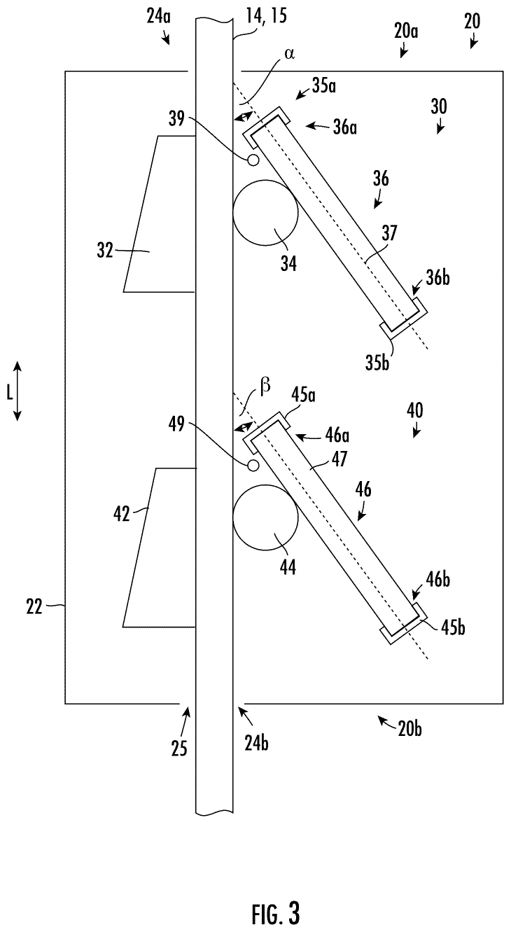

FIG. 3 depicts a schematic plan view of an elevator safety brake arrangement 20 according to an exemplary embodiment of the invention in an activated condition.

The elevator safety brake arrangement 20 depicted in FIG. 3 comprises a housing 22. When the elevator safety brake arrangement 20 is installed within an elevator system 2, the housing 22 is closed, e.g. by a cover plate, which is not shown in FIG. 3. In FIG. 3, the housing 22 is depicted in an open state without the cover plate, in order to show the internal structure of the elevator safety brake arrangement 20.

A first opening 24a is formed in a top portion of the housing 22, and a second opening 24b is formed in a bottom portion of the housing 22. The two openings 24a, 24b provide a passage 25 extending in a longitudinal direction L through the elevator safety brake arrangement 20. The passage 25 allows an elevator guide member 14, 15 to pass through the elevator safety brake arrangement 20.

The elevator safety brake arrangement 20 comprises a first safety brake 30 and a second safety brake 40, which are arranged next to each other along the longitudinal direction L.

The first safety brake 30 comprises a first brake shoe 32, which is supported by the housing 22 and arranged on one side of the passage 25.

The first safety brake 30 further comprises a first roller 34 and a first elastic element 36, which are supported by the housing 22 and arranged on an opposite side of the passage 25. In consequence, a guide member 14, 15 extending through the passage 25 is arranged between the first brake shoe 32 on one side of the guide member 14, 15, and the first roller 34 and the first elastic element 36 on the other side of the guide member 14, 15.

The first roller 34 is capable of rolling along the longitudinal extension of the guide member 14, 15 along the longitudinal direction L.

In the embodiment depicted in FIG. 3, both ends 36a, 36b of first elastic element 36 are fixed to the housing 22, in particular by first fixtures 35a, 35b, which are configured for fixing the ends of the first elastic element 36 to the housing 22.

In an alternative embodiment, which is not depicted in the figures, only one end 36a, 36b of the first elastic element 36 may be fixed to the housing 22, and the other end 36a, 36b of the first elastic element 36 may be a free end, which is not fixed to the housing 22, so that it is movable with respect to the housing 22.

The first elastic element 36 may be fixed within the first fixtures 35a, 35b by fixing elements, which are not explicitly shown in FIG. 3. Such fixing elements may include screws or bolts, extending through the first elastic element 36. Alternatively or additionally, the first elastic element 36 may be fixed to the first fixtures 35a, 35b by clamping, soldering, welding or adhesive bonding.

The first elastic element 36 extends at a first angle α with respect to the passage 25, defining a tapered region between the guide member 14, 15 and the first elastic element 36. The first elastic element 36 may, for example, be arranged at a first angle α in the range of between 3° and 15° with respect to the guide member 14, 15.

The first elastic element 36 has a proximal end 36a and a distal end 36b, with the proximal end 36a being arranged closer to the guide member 14, 15 than the distal end 36b of the first elastic element 36. The proximal end 36a may be arranged in a distance in the range between 20 mm and 25 mm, in particular in a distance of 22 mm, from the guide member 14, 15.

In the orientation of the elevator safety brake arrangement 20 depicted in FIG. 3, the proximal end 36a is the upper end of the first elastic element 36 facing an upper first end 20a of the elevator safety brake arrangement 20, and the distal end 36b, is the lower end of the first elastic element 36, facing a lower second end 20b of the elevator safety brake arrangement 20.

The first roller 34 is movably arranged within the tapered region defined by the guide member 14, 15 and the first elastic element 36. The first roller 34 may have a diameter in the range between 20 mm and 30 mm, the first roller 34 may in particular have a diameter of mm.

When the first elevator safety brake 30 is in a standby configuration, in which the first elevator safety brake 30 is not activated, the first roller 34 is located in a standby position, in which it does not contact the guide member 14, 15. In the standby configuration, the first elevator safety brake 30 is capable of moving freely along the guide member 14, 15.

The standby position of the first roller 34 may, in particular, be in the vicinity to the distal end 36b of the first elastic element 36.

For activating the first elevator safety brake 30, the first roller 34 is moved towards the guide member 14, 15 by an actuator, which is not depicted in the figures.

More particularly, for activating the first elevator safety brake 30, the first roller 34 may be moved upwards by the actuator. Due of the inclined orientation of the first elastic element 36, the roller 34 will additionally be moved horizontally towards the guide member 14, 15.

The first roller 34 contacting the guide member 14, 15 results in a frictional engagement between the first roller 34 and the guide member 14, 15. As a result of said frictional engagement, a downward movement of the first elevator safety brake 30 with respect to the guide member 14, 15 causes the first roller 34 to roll along the guide member 14, 15 on one side (the left side of the roller in FIG. 3) and to roll upwards along the first elastic element 36 on the other side (the right side of the first roller 34 in FIG. 3).

Due to the inclined orientation of the first elastic element 36 with respect to the guide member 14, 15, this movement of the first roller 34 causes the first roller 34 to move into a wedged condition, in which the first roller 34 is sandwiched between the guide member 14, 15 and the first elastic element 36, as illustrated in FIG. 3.

The first elevator safety brake 30 may further comprise a first stopper 39, which is arranged in the vicinity of the proximal end 36a of the first elastic element 36, for preventing the first roller 34 from moving beyond the proximal end 36a of the first elastic element 36.

The first stopper 39 may be attached to and supported by the housing 22. The first stopper 39 may also be formed integrally with the housing 22, i.e. as a portion of the housing 22.

In the wedged condition, the first elastic element 36 presses the first roller 34 against the guide member 14, 15, generating a frictional braking force between the guide member 14, 15 and the first brake shoe 32 of the first elevator safety brake 30.

Additional frictional braking forces are generated between the first roller 34 and the first elastic element 36, and between the first roller 34 and the first stopper 39, respectively.

The combination of the frictional braking forces brakes the movement of the first elevator safety brake 30 with respect to the guide member 14, 15, until said movement has been stopped.

The first elevator safety brake 30 may further comprise a first stopper 39, which is arranged in the vicinity of the proximal end 36a of the first elastic element 36, for preventing the first roller 34 from moving beyond the proximal end 36a of the first elastic element 36.

The first stopper 39 may be attached to and supported by the housing 22. The first stopper 39 may also be formed integrally with the housing 22, i.e. as a portion of the housing 22.

The second safety brake 40 comprises a second brake shoe 42 supported by the housing 22 and arranged on one side of the passage 25.

The second safety brake 40 further comprises a second roller 44 and a second elastic element 46, which are supported by the housing 22 and arranged on an opposite of side of the passage 25, so that a guide member 14, 15 extending through the passage 25 is arranged between the second brake shoe 42 on one side, and the second roller 44 and the second elastic element 46 on the other side.

The second roller 44 is capable of rolling along the longitudinal extension of the guide member 14, 15.

In the embodiment depicted in FIG. 3, both ends of the second elastic element 46 are fixed to the housing 22, in particular by second fixtures 45a, 45b, which are configured for fixing the ends of the second elastic element 46 to the housing 22.

In an alternative embodiment, which is not depicted in the figures, only one end of the second elastic element 46 may be fixed to the housing 22, and the other end of the second elastic element 46 may be a free end, which is not fixed to the housing 22, so that it is movable with respect to the housing 22.

The second elastic element 46 may be fixed within the second fixtures 45a, 45b by fixing elements, which are not shown in FIG. 3. Such fixing elements may include screws or bolts, extending through the second elastic element 46. Alternatively or additionally, the second elastic element 46 may be fixed to the second fixtures 45a, 45b by clamping, soldering, welding or adhesive bonding.

The second elastic element 46 extends at a second angle β with respect to the passage 25, defining a tapered region between the guide member 14, 15 and the second elastic element 46. The second elastic element 46 may, for example, be arranged at a second angle β in the range of between 3° and 15° with respect to the guide member 14, 15.

The second elastic element 46 has a proximal end 46a and a distal end 46b, with the proximal end 46a being arranged closer to the guide member 14, 15 than the distal end 46b of the second elastic element 46. The proximal end 46a may be arranged in a distance in the range between 20 mm and 25 mm, in particular in a distance of 22 mm, from the guide member 14, 15.

In the orientation of the elevator safety brake arrangement 20 depicted in FIG. 3, the proximal end 46a is the upper end of the second elastic element 46, facing the upper first end 20a of the elevator safety brake arrangement 20, and the distal end 46b is the lower end of the second elastic element 46, facing the lower second end 20b of the elevator safety brake arrangement 20.

The second roller 44 is movably arranged within the tapered region defined by the guide member 14, 15 and the second elastic element 46. The second roller 44 may have a diameter in the range between 20 mm and 30 mm, the second roller 44 may in particular have a diameter of 25 mm.

When the second elevator safety brake 40 is in a standby configuration, in which the second elevator safety brake 40 is not activated, the second roller 44 is located in a standby position, in which it does not contact the guide member 14, 15. In the standby configuration, the second elevator safety brake 40 is capable of moving freely along the guide member 14, 15.

The standby position of the second roller 44 may, in particular, be in the vicinity to the distal end 46b of the second elastic element 46.

For activating the second elevator safety brake 40, the second roller 44 is moved towards the guide member 14, 15 by an actuator, which is not depicted in the figures.

More particularly, for activating the second elevator safety brake 30, the second roller 44 may be moved upwards by the actuator, and due to the inclined orientation of the second elastic element 46, the second roller 44 will then also move horizontally towards the guide member 14, 15.

For activating the first and second elevator safety brakes 30, 40, the first and second rollers 34, 44 may be moved by the same actuator. In other words, the elevator safety brake arrangement 20 may be equipped with a single actuator, which is configured for activating both the first and second elevator safety brakes 30, 40.

In an alternative embodiment, two separate actuators may be provided for moving the first and second rollers 34, 44, respectively. The two separate actuators may be configured for actuating the first and second safety brakes 30, 40 independent of each other.

The second roller 44 contacting the guide member 14, 15 results in a frictional engagement between the second roller 44 and the guide member 14, 15. As a result of said frictional engagement, a downward movement of the second elevator safety brake 40 with respect to the guide member 14, 15 causes the second roller 44 to roll along the guide member 14, 15 on one side (the left side of the roller in FIG. 3) and to roll upwards along the second elastic element 46 on the other side (the right side of the second roller 44 in FIG. 3).

Due to the inclined orientation of the second elastic element 46 with respect to the guide member 14, 15, this movement of the second roller 44 causes the second roller 44 to move into a wedged condition, in which the second roller 44 is sandwiched between the guide member 14, 15 and the second elastic element 46, as illustrated in FIG. 3.

The second elevator safety brake 40 may further comprise a second stopper 49, which is located in the vicinity of the proximal end 46a of the second elastic element 46, and which is configured for preventing the second roller 44 from moving beyond the proximal end 46a of the second elastic element 46.

The second stopper 49 may be attached to and supported by the housing 22. The stopper 49 may also be formed integrally with the housing 22, i.e. as a portion of the housing 22.

In the wedged condition, the second elastic element 46 presses the second roller 44 against the guide member 14, 15, thereby generating a frictional braking force between the guide member 14, 15 and the second brake shoe 42 of the second elevator safety brake 40.

Additional frictional braking forces are generated between the second roller 44 and the second elastic element 46, and between the second roller 44 and the second stopper 49, respectively.

The combination of the frictional braking forces brake the movement of the second elevator safety brake 40 with respect to the guide member 14, 15, until said movement has been stopped.

The second elevator safety brake 40 may further comprise a second stopper 49, which is located in the vicinity of the proximal end 46a of the second elastic element 46, and which is configured for preventing the second roller 44 from moving beyond the proximal end 46a of the second elastic element 46.

The second stopper 49 may be attached to and supported by the housing 22. The stopper 49 may also be formed integrally with the housing 22, i.e. as a portion of the housing 22.

The first and second elastic element 36, 46 may have a length L of not more than 60 mm, respectively. The first elastic element 36, 46 may in particular have a length of 54 mm to 58 mm, respectively. Elastic elements 36, 46 having a length in this range have been found as reliably providing sufficiently large braking forces, and, simultaneously allow reducing the dimensions of the elevator safety brake.

The first elastic element 36 may be a spring assembly comprising at least one first leaf spring 37. Optionally, the first elastic element 36 may comprise a leaf spring package including a plurality of first leaf springs 37. The first elastic element 36 may in particular comprise a plurality of first leaf springs 37 that are arranged in a sandwich structure on top of each other forming a stack of first leaf springs 37.

The first elastic element 36 may comprise a plurality of equal first leaf springs 37, or a plurality of first leaf springs 37, which differ from each other.

The second elastic element 46 may be a spring assembly comprising at least one second leaf spring 47. Optionally, the second elastic element 46 may comprise a leaf spring package including a plurality of second leaf springs 47. The second elastic element 46 may in particular comprise a plurality of second leaf springs 47 that are arranged in a sandwich structure on top of each other forming a stack of second leaf springs 47.

If the first or second elastic element 36, 46 consists of a single leaf spring 37, 47, it may, for example, have a thickness at its thinnest point, which is in the range of between 3 mm and 5 mm. A first or second elastic element 36, 46, which is designed for heavier loads and which comprises a stack of plurality of leaf springs 37, 47, may, for example, have a total thickness of more than 15 mm.

In an elevator safety brake arrangement 20 according to an exemplary embodiment of the invention, the elastic properties of the first elastic element 36 differ from the elastic properties of the second elastic element 46.

In consequence, when the elevator safety brake arrangement 20 has been activated so that the first roller 34 rolls along the guide member 14, 15 and the first elastic element 36 and the second roller 44 rolls along the guide member 14, 15 and the second elastic element 46, as it has been described before, the elastic forces, which are applied to the first roller 34 by the first elastic element 36 differ from the elastic forces, which are applied to the second roller 44 by the second elastic element 46.

Providing the first elastic element 36 and the second elastic element 46 with different elastic properties, in particular allows individually adjusting the forces pressing the first and second rollers 34, 44 against the guide member 14, 15, when the elevator safety brake arrangement 20 has been activated.

When an elevator safety brake arrangement 20 comprising two safety brakes 30, 40, which are spaced apart from each other, as it is depicted in FIG. 3, moves downwards along the guide member 14, 15, the second roller 44 of the second (lower) safety brake 40 contacts a “fresh” portion of the guide member 14, 15, i.e. a portion of the guide member 14, 15, which is in its original (“new”) state, whereas the first roller 34 of the first (upper) safety brake 30 contacts a “used” portion of the guide member 14, 15, i.e. a portion of the guide member 14, 15, which already has been contacted by the second roller 44. This previous contact between the guide member 14, 15 and the second roller 44 may have altered the surface of the guide member 14, 15.

As a result, the adhesive and/or frictional forces generated between the first roller 34 and the guide member 14, 15 on one side and the adhesive and/or frictional forces generated between second roller 44 and the guide member 14, 15 on the other side may differ, when the elevator safety brake arrangement 20 moves downwards along the guide member 14, 15.

The second roller 44 may, for example, have created scratches, dents or other marks on the surface of the guide member 14, 15. Alternatively or additionally, material of the second roller 44, which has separated from the second roller 44, may now stick to the guide member 14, 15, thereby changing the adhesive and/or frictional properties of the guide member 14, 15.

In an elevator safety brake arrangement 20 according to an exemplary embodiment of the invention, the elastic properties of the first and second elastic elements 36, 46 may in particular be set differently for at least partially compensating for different adhesive and/or frictional properties of “new” and “used” portions of the guide member 14, 15, i.e. between portions of the guide member 14, 15, which are in an original state, since they have not been in contact with a brake shoe 32, 42 or a roller 34, 44 of a safety brake 30, 40, and portions of the guide member 14, 15, which are not in the original state anymore, since they have been in contact with the second brake shoe 42 and/or with the second roller 44 of the second safety brake 40.

At least partially compensating for different adhesive and/or frictional properties of “new” and “used” portions of the guide member 14, 15 allows for a more even distribution of the braking loads applied to the at least two safety brakes 30, 40.

In an elevator safety brake arrangement 20 according to an exemplary embodiment of the invention, the elastic properties of the first and second elastic elements 36, 46 may be set differently for at least partially compensating for different adhesive and/or frictional properties of different portions of the guide member 14, 15.

Apparently, the forces which are applied to each of the first and second rollers 34, 44 vary when the first and second rollers 34, 44 roll along the elastic elements 36, 46.

The forces which are applied to each of the first and second rollers 34, 44 when the first and second rollers 34, 44 roll along the elastic elements 36, 46 in particular increase when the rollers 34, 44 approach the proximal end 36a of the first elastic elements 36 or the proximal end 46a of the second elastic element 46, respectively, as the rollers 34, 44 are increasingly wedged between the first and second elastic elements 36, 46.

In an exemplary embodiment, the elastic properties of the first and second elastic elements 36, 46 may be set so that the average force applied to the first roller 34, when it rolls along its the first elastic element 36, is larger than the average force applied to the second roller 44, when it rolls along its the second elastic element 46.

In an alternative exemplary embodiment, the elastic properties of the first and second elastic elements 36, 46 may be set so that the average force applied to the first roller 34, when it rolls along its the first elastic element 36, is smaller than the average force applied to the second roller 44, when it rolls along its the second elastic element 46.

The first elastic element 36 may, for example, have a different elastic module than the second elastic element 46. The first elastic element 36 may, in particular, be made of a first material and the second elastic element 46 may be made of a second material, which differs from the first material, and wherein the second material has a different elastic module than the first material.

Alternatively or additionally, the first elastic element 36 may have a different length and/or a different thickness than the second elastic element 46, resulting in different elastic properties of the first and second elastic elements 36, 46.

In the exemplary embodiment schematically depicted in FIG. 3, the first elastic element 36 and the second elastic element 46 are arranged with the same inclination, i.e. at identical angles α=β, with respect to the passage 25 and the guide member 14, 15.

In further embodiments, which are not explicitly depicted in the Figures, the first elastic element 36 and the second elastic element 46 may be arranged with different inclinations, i.e. with different angles α≠β, with respect to the passage 25 and the guide member 14, 15.

In the exemplary embodiment schematically depicted in FIG. 3, the first brake shoe 32 and the second brake shoe 42 are arranged on the same (first) side of the passage 25, and the first elastic element 36 and the second elastic element 46 are arranged on the same opposite (second) side of the passage 25.

In an alternative embodiment, which is not explicitly depicted in the figures, the first brake shoe 32 and the second brake shoe 42 may be arranged on opposite sides of the passage 25. Correspondingly, the first elastic element 36 and the second elastic element 46 may be arranged on opposite sides of the passage 25 as well.

In the exemplary embodiment of an elevator safety brake arrangement 20 depicted in FIG. 3, the first and second safety brakes 30, 40 are arranged in a common housing 22, forming a single integrated safety brake arrangement 20.

Providing a single integrated safety brake arrangement 20, in which the first and second safety brakes 30, 40 are arranged within a common housing 22, facilitates the installation of the safety brake arrangement 20 at an elevator car 6 or at an elevator counterweight 21, as only a single device needs to be attached to the elevator car 6 or at the elevator counterweight 21, respectively.

In an alternative embodiment, the first and second safety brakes 30, 40 may be provided separately of each other, in particular in two separate housings 22.

Providing the first and second safety brakes 30, 40 separately from each other may allow varying the distance between the first and second safety brakes 30, 40 along the longitudinal direction L. This may provide additional flexibility for mounting the first and second safety brakes 30, 40 to an elevator car 6 or to an elevator counterweight 21, respectively.

The embodiment of a safety brake arrangement 20 depicted in FIG. 3 is configured for braking a downward movement of the safety brake arrangement 20 with respect to the guide member 14, 15.

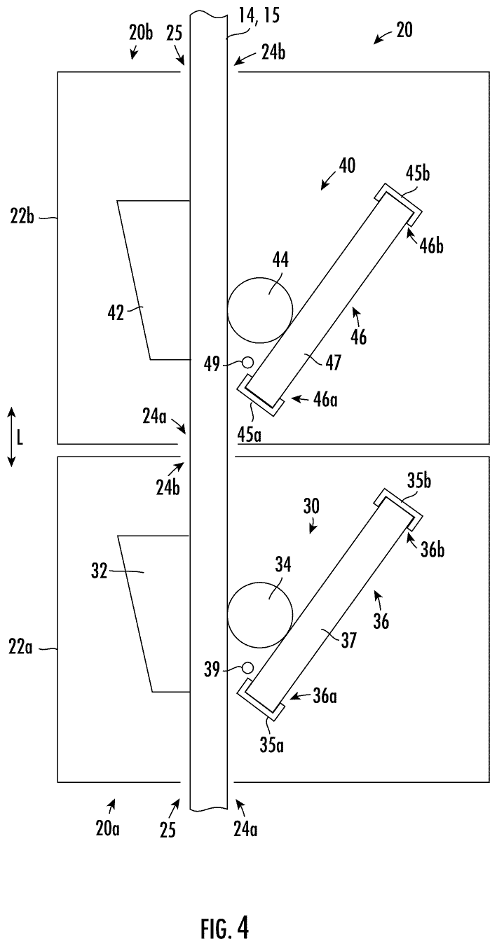

FIG. 4 schematically depicts a further exemplary embodiment of a safety brake arrangement 20, which is configured for braking an upward movement of the safety brake arrangement 20.

The exemplary embodiment of a safety brake arrangement 20 depicted in FIG. 4 comprises basically the same features as the exemplary embodiment of a safety brake arrangement 20 depicted in FIG. 3.

In FIG. 4, these identical features are denoted with the same reference signs and they are not discussed in detail again. The above description of the embodiment depicted in FIG. 3 correspondingly applies to the features of the embodiment depicted in FIG. 4 except for the differences, which are discussed in the following.

The safety brake arrangement 20 depicted in FIG. 4 is oriented in an upside-down configuration with respect to the embodiment depicted in FIG. 3.

As a result, after the first and second safety brakes 30, 40 have been activated, the movement of the first and second rollers 34, 44 into the wedged condition, in which the respective roller 34, 44 is sandwiched between the guide member 14, 15 and the corresponding elastic element 36, 46, is not caused by a downward movement of the safety brake arrangement 20, but by an upward movement of the safety brake arrangement 20 with respect to the guide member 14, 15.

In consequence, the exemplary embodiment of a safety brake arrangement 20 depicted in FIG. 4 is configured for braking an upward movement of the safety brake arrangement 20 with respect to the guide member 14, 15.

Further, in the exemplary embodiment of a safety brake arrangement 20 depicted in FIG. 4, each of the first and second safety brakes 20, 30 is provided with its own housing 22a, 22b.

An elevator car 6 according to an exemplary embodiment of the invention may be provided with at least one safety brake arrangement 20, which is configured for braking a downward movement of the elevator car 6, as it is depicted in FIG. 3, and/or with at least one safety brake arrangement 20, which is configured for braking an upward movement of the elevator car 6, as it is depicted in FIG. 4, in order to reliably prevent potential dangerous movements of the elevator car 6.

Similarly, an elevator counterweight 21 according to an exemplary embodiment of the invention may be provided with at least one safety brake arrangement 20, which is configured for braking a downward movement of the elevator counterweight 21, and/or with at least one safety brake arrangement 20, which is configured for braking an upward movement of the elevator counterweight 21, in order to reliably prevent potential dangerous movements of the elevator counterweight 21.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

What is claimed is:

1. Elevator safety brake arrangement (20) for being attached to an elevator car (6) or to an elevator counterweight (21) and configured for braking movement of the elevator car (6) or of the elevator counterweight (21) in an emergency situation;
the elevator safety brake arrangement (20) defining a passage (25) extending in a longitudinal direction (L) and allowing a longitudinal guide member (14, 15), such as a guide rail, to pass through;
the elevator safety brake arrangement (20) comprising a first safety brake (30) and a second safety brake (40),
wherein the first safety brake (30) comprises:
a first brake shoe (32) arranged on one side of the passage (25);
a first roller (34) and a first elastic element (36) arranged on an opposite side of the passage (25);
the first elastic element (36) extending at a first angle (α) with respect to the longitudinal direction (L), with a proximal end (36a) of the first elastic element (36) being closer to the passage (25) than a distal end (36b) of the first elastic element (36), thereby defining a first tapered region between the passage (25) and the first elastic element (36),
wherein the first roller (34) is, at least in an activated condition of the first safety brake (30), located within said first tapered region defined by the passage (25) and the first elastic element (36); and
wherein the first roller (34) is capable of moving along the first elastic element (36) towards the proximal end (36a) of the first elastic element (36) into a wedged condition between the first elastic element (36) and a guide member (14, 15) passing through the passage (25), in which the first elastic element (36) exerts a first pressing force onto the first roller (34);
wherein the second safety brake (40) comprises:
a second brake shoe (42) arranged on one side of the passage (25);
a second roller (44) and a second elastic element (46) arranged on an opposite side of the passage (25);
the second elastic element (46) extending at a second angle (β) with respect to the longitudinal direction (L), with a proximal end (46a) of the second elastic element (46) being closer to the guide member (14, 15) than a distal end (46b) of the second elastic element (46), thereby defining a second tapered region between the passage (25) and the second elastic element (46);
wherein the second roller (44) is, at least in an activated condition of the second safety brake (40), located within said second tapered region defined by the the passage (25) and the second elastic element (46); and
wherein the second roller (44) is capable of moving along the second elastic element (46) towards the proximal end (46a) of the second elastic element (46) into a wedged condition between the second elastic element (46) and the guide member (14, 15) passing through the passage (25), in which the second elastic element (46) exerts a second pressing force onto the second roller (44);
wherein the proximal ends (36a, 46a) of the first and second elastic elements (36, 46) are oriented towards a first end (20a) of the elevator safety brake arrangement (20), and wherein the distal ends (36b, 46b) of the first and second elastic element (36, 46) are oriented towards a second end (20b) of the elevator safety brake arrangement (20), which is opposite to the first end (20a) of the elevator safety brake arrangement (20) along the longitudinal direction (L); and
wherein the elastic properties of the first elastic element (36) differ from the elastic properties of the second elastic element (46).

2. Elevator safety brake arrangement (20) according to claim 1,
wherein the first and second safety brakes (30, 40) are combined with each other forming a single elevator safety brake; or
wherein the first and second safety brakes (30, 40) are provided separately from each other as two elevator safety brakes (30, 40).

3. Elevator safety brake arrangement (20) according to claim 1, wherein the first elastic element (36) has a different elastic module than the second elastic element (46).

4. Elevator safety brake arrangement (20) according to claim 1, wherein the first elastic element (36) has a different length and/or a different thickness than the second elastic element (46).

5. Elevator safety brake arrangement (20) according to claim 1,
wherein the first elastic element (36) is made of a first material and the second elastic element is made of a second material, which differs from the first material;
wherein the second material has in particular a different elastic module than the first material.

6. Elevator safety brake arrangement (20) according to claim 1, wherein the first angle (α) differs from the second angle (β).

7. Elevator safety brake arrangement (20) according to claim 1,
wherein the first elastic element (36) and the second elastic element (46) are arranged at the same angle (α, β) with respect to the longitudinal direction (L).

8. Elevator safety brake arrangement (20) according to claim 1, wherein at least one of the first and second elastic elements (36, 46) comprises at least one leaf spring (37, 47).

9. Elevator safety brake arrangement (20) according to claim 8, wherein at least one of the first and second elastic elements (36, 46) comprises a leaf spring package including a plurality of leaf springs (37, 47), wherein the second elastic element (46) comprises in particular a different number of leaf springs (37, 47) than the first elastic element (36).

10. Elevator safety brake arrangement (20) according to claim 1,
wherein the first and second elastic elements (36, 46) are located on the same side of the passage (25); or
wherein the first and second elastic elements (36, 46) are located on opposite sides of the passage (25).

11. Elevator safety brake arrangement (20) according to claim 1, wherein the first and second safety brakes (30, 40) are spaced apart from each other along the longitudinal direction (L).

12. Elevator system (2) comprising:
a hoistway (4), extending between a plurality of landings (8);
at least one guide member (14, 15), extending in a longitudinal direction (L) within the hoistway (4) between the plurality of landings (8);
at least one elevator car (6), configured for moving along the elevator car guide member (14) between the plurality of landings (8); and
at least one elevator safety brake arrangement (20) according to claim 1, which is attached to the at least one elevator car (6), wherein the at least one elevator car guide member (14) passes through the passage (25) formed by the at least one elevator safety brake arrangement (20).

13. Elevator system (2) according to claim 12, further comprising:
at least one elevator counterweight (21), configured for moving concurrently and in opposite direction with respect to the at least one elevator car (6) along at least one elevator counterweight elevator car guide member (15); and
at least one elevator safety brake arrangement (20) which is attached to the at least one elevator counterweight (21), wherein the at least one elevator counterweight guide member (15) passes through the passage (25) defined by the elevator safety brake arrangement (20).

14. Elevator system (2) according to claim 12,
wherein, in at least one elevator safety brake arrangement (20), the proximal end (36a) of the first elastic element (36) is arranged above the distal end (36b) of the first elastic element (36); and the proximal end (46a) of the second elastic element (46) is arranged above the distal end (46b) of the second elastic element (46).

15. Elevator system (2) according to claim 12,
wherein, in at least one elevator safety brake arrangement (20), the proximal end (36a) of the first of the first elastic element (36) is arranged below the distal end (36b) of the first elastic element (36); and the proximal end (46a) of the first of the second elastic element (46) is arranged below the distal end (46b) of the second elastic element (46).
